(19) United States
(12) Patent Application Publication
(10) Pub. No.: US 2026/0034546 A1
(43) Pub. Date: Feb. 5, 2026

(54) APPARATUS TO PREVENT LIQUID EVAPORATION IN A MICROPLATE

(71) Applicant: Gator Bio (Suzhou) Co., Ltd., Suzhou (CN)

(72) Inventors: Zhendong Bie, Shanghai (CN); Chao Xie, Shanghai (CN); Qingqing Wang, Shanghai (CN); Genqian Li, Shanghai (CN)

(21) Appl. No.: 19/357,984

(22) Filed: Oct. 14, 2025

Related U.S. Application Data
(63) Continuation of application No. PCT/CN2024/087936, filed on Apr. 16, 2024.

(30) Foreign Application Priority Data
Apr. 17, 2023 (CN) 202320850573.8

(51) Int. Cl. B01L 3/00

(52) U.S. Cl. CPC B01L 3/50853; B01L 2200/025; B01L 2200/142; B01L 2300/042

(57) ABSTRACT

Various implementations generally relate to a device to prevent or reduce liquid evaporation in microplate wells using a system of movable bars. The device includes multiple layers, including a base with a cavity configured to place a microplate, a set of movable bars placed on the upper surface of the base and configured to open or close portions of wells of the microplate, and a cover plate placed on top of the set of movable bars, wherein the cover plate is configured to hold the multiple layers of the device in place.

### CROSS-REFERENCE TO RELATED APPLICATIONS

This application is a continuation of PCT/CN2024/087936, filed April 16, 2024; which claims priority to Chinese application CN202320850573.8, filed April 17, 2023. The contents of the above-identified applications are incorporated herein by reference in their entirety.

### TECHNICAL FIELD

The present invention relates to an apparatus to prevent liquid evaporation in a microplate. The apparatus utilizes multiple movable bars that are each enabled to open or close a portion of wells of a microplate to reduce liquid evaporation from the wells.

### BACKGROUND

A microplate, also known as a microtiter plate, is a flat plate with multiple wells used as small test tubes. Microplates have become a standard tool in analytical research and clinical diagnostic testing laboratories. Microplates are typically arranged in a rectangular matrix of wells. Common configurations include a 8-by-12 96-well microplate with row and column spacings of 9mm and a 16-by-24 384-well microplate with row and column spacings of 4.5mm.

A common problem related to microplates is evaporation of medium stored in the wells. Due to the small volume of medium used within each well, with wells located around the perimeters of microplates more susceptible, evaporation of medium stored in the wells is inevitable. To slow the rate of evaporation, a cover, such as a thin film or a sealing tape, has been introduced to cover the wells when a microplate is not in use. However, such methods have a few shortcomings. When a thin film is used, a liquid pipe needs to penetrate the thin film covering a well and extend into the well storing liquid. Additionally, when extracting liquid from the well, the film may be contaminated during the extraction process, negatively affecting test results. Further, because an individual can only work with one well at a given time, the thin film prevents efficient extraction or addition of liquids in multiple wells of the microplate.

Therefore, existing microplate covers currently available are not suitable for efficiently reducing or preventing evaporation of liquids stored in microplate wells. There is a need to overcome the limitations of existing microplate covers.

### BRIEF DESCRIPTION OF THE DRAWINGS

Detailed descriptions of implementations of the present invention will be described and explained through the use of the accompanying drawings.

FIG. 1 is one example of a structural diagram that illustrates a layout of an anti-evaporation device to prevent liquid evaporation in a microplate according to the first aspect of the present invention.

FIG. 2 is a diagram that illustrates a top view of the anti-evaporation device, according to the first aspect of the present invention.

FIG. 3 is a diagram that illustrates a cross-sectional view of the anti-evaporation device, according to some implementations.

FIG. 4 is a diagram that illustrates an exploded view of the anti-evaporation device, according to the second aspect of the present invention.

FIG. 5 is a diagram that illustrates a cross-sectional view of the anti-evaporation device, according to some implementations.

FIG. 6 is a diagram that illustrates a perspective view of the anti-evaporation device according to the second aspect of the present invention.

FIG. 7 is a diagram that illustrates another perspective view of the anti-evaporation device according to the second aspect of the present invention.

FIG. 8 is a flowchart illustrating a representative process to reduce evaporation of liquids in a microplate, according to one embodiment of the first aspect of the invention.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### DETAILED DESCRIPTION

The disclosed technology relates to an apparatus or a device designed to reduce or prevent liquid evaporation in microplate wells using a system of movable bars. The device utilizes multiple movable bars that are each enabled to open or close a portion of wells of a microplate to reduce liquid evaporation from the wells. The device can include multiple layers, including a base with a cavity configured to place a microplate, a set of movable bars placed on an upper surface of the base and configured to open or close portions of wells of the microplate, and a cover placed on top of the set of movable bars, wherein the cover is configured to hold the multiple layers of the device in place.

In the description of the scheme, it should be noted that the terms "center," "upper," "lower," "left," "right," "front," "back," "vertical," "horizontal," orientations or positional relationships indicated by "inner," "outside," etc. are based on the orientations or positional relationships shown in the drawings and are only for convenience and simplicity of description and thus do not indicate or imply that the device or element referred to must have a specific orientation.

In the first aspect, the present invention is directed to an apparatus to prevent liquid evaporation in a microplate, comprising: (a) a base having an upper surface and a cavity wherein the cavity is configured to hold a microplate having columns and rows of wells for storing liquids, wherein the upper surface of the base includes one or two columns of oblong-shaped grooves located outside of the microplate location, wherein each oblong-shaped groove is laterally adjacent to each row of the wells; (b) a middle plate on top of the upper surface of the base to cover the cavity, wherein the middle plate comprises (i) multiple movable bars and (ii) one or two columns of oblong-shaped holes wherein the one or two columns of oblong-shaped holes corresponds to the one or two columns of oblong-shaped grooves of the base, wherein a number of the multiple movable bars is equal to the number of the rows of the wells, each of the movable bars comprising perforations corresponding to the wells of the microplate and at least one circle-shaped hole, and each of the movable bars is movable along a direction of the oblong-shaped grooves to open or close the wells; and (c) a cover plate on top of the middle plate and covering the middle plate and the base, wherein the cover plate comprises (i) openings corresponding to the wells of the microplates, and (ii) one or two columns of oblong-shaped holes, wherein the one or two columns of oblong-shaped holes of the cover plate corresponds to the one or two columns of oblong-shaped grooves of the base.

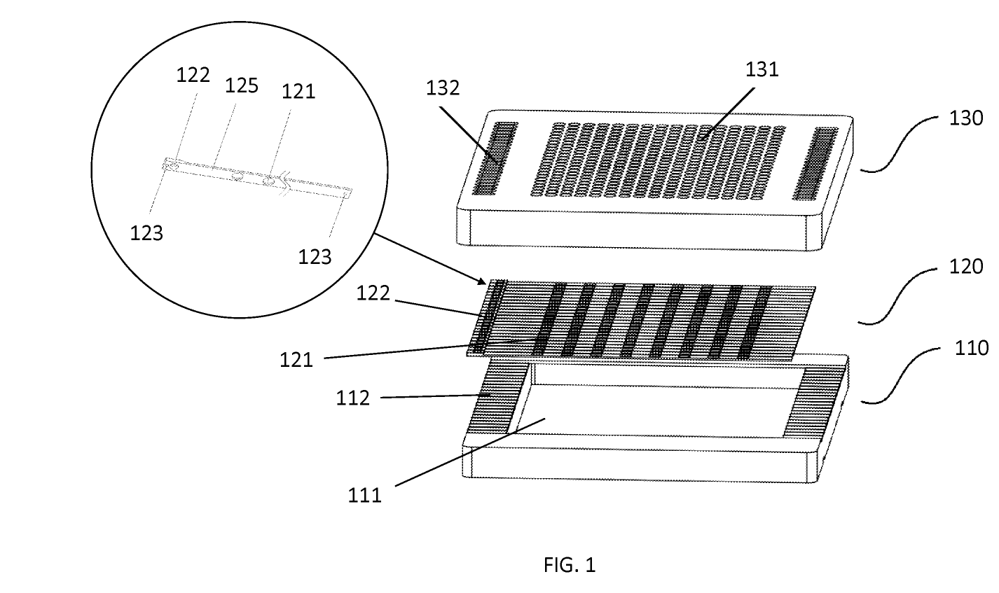

FIG. 1 is one example of a structural diagram that illustrates a layout of an anti-evaporation device to prevent liquid evaporation in a microplate according to the first aspect of the present invention. As shown in FIG. 1, the anti-evaporation device includes multiple layers including a base 110, a middle plate 120, and a cover plate 130. The base 110 includes a cavity 111 that is configured to hold a microplate with wells for storing liquids. The base 110 includes one or two columns of oblong-shaped grooves 112 located outside of the microplate location on an upper surface of the base 110, wherein each oblong-shaped groove is laterally adjacent to each row of the wells of the microplate. In configurations where the base 110 includes two columns of oblong-shaped grooves 112, each column of oblong-shaped grooves is located outside of and adjacent to opposite lateral ends of the cavity such that two oblong-shaped grooves are located at each end of each row of the wells.

The middle plate 120 includes multiple movable bars 125, wherein the number of multiple movable bars 125 is equal to the number of rows of wells in the microplate. Each of the multiple movable bars 125 includes perforations 121 corresponding to the wells of the microplate. The size of the perforations 121 can be equal to or smaller than the openings of the microplate wells. Each of the multiple movable bars 125 also includes at least one circle-shaped hole 122 located at a lateral end of each of the multiple movable bars 125.

In some embodiments, each of the multiple movable bars 125 includes protruding points 123 configured to engage with slots in the cover plate 130 to align the layers of the anti-evaporation device. The multiple movable bars 125 are configured to be placed on the upper surface of the base 110 such that the circle-shaped holes 122 are aligned with the oblong-shaped grooves 112. The diameter of each circle-shaped hole 122 is equal to the short side of the corresponding oblong-shaped groove 112 such that the circle-shaped hole 122 is configured to move only along the direction of the oblong-shaped groove 112. The multiple movable bars 125 can be made of materials with anti-fouling and/or anti-corrosion properties, including but not limited to, acrylic boards.

In some embodiments, instead of a circle-shaped hole 122, each of the multiple movable bars 125 includes a square-shaped hole, wherein the oblong-shaped grooves that are aligned with the square-shaped holes are a shape of an extended rectangle with the shorter dimension equal to the length of the square-shaped holes. The square-shaped holes are configured to move only in the direction of the rectangular oblong-shaped grooves.

In other embodiments, the multiple movable bars 125 are configured to be foldable such that driving the multiple movable bars 125 along the direction of the oblong-shaped grooves 112 results in the multiple movable bars 125 folding or flattening, resulting in opening or closing of corresponding wells.

The cover plate 130 can be placed on top of the middle plate 120 such that the cover plate 130 fully or partially covers the other layers of the anti-evaporation device. The cover plate 130 includes openings 131 corresponding to the wells of the microplate and one or two columns of oblong-shaped holes 132 next to the openings 131. In some embodiments, openings 131 are replaced with a single opening that is large enough to expose all wells of the microplate. The oblong-shaped holes 132 are configured to be aligned with the oblong-shaped grooves 112 of the base 110.

In some embodiments, the middle plate 120 only includes the multiple movable bars 125. The multiple movable bars 125 are placed on the upper surface of the base 110, after which the cover plate 130 is placed on top of the multiple movable bars 125 to fully cover the multiple movable bars 125 and the base 110.

An equipment, such as a driving rod with a diameter less than or equal to that of the circle-shaped holes 122, can be used to drive the movement of the multiple movable bars 125. For example, the driving rod can pass through the oblong-shaped hole 132 of the cover plate 130 and the circle-shaped hole 122 of the corresponding movable bar 125 to drive the corresponding perforations 121 to correspond or to misalign with the row of wells so as to open or close the row of wells. When a well is closed, liquids stored in the well is reduced from direct exposure to air, reducing or preventing evaporation. In some embodiments, the equipment is a series of levers that can be fixedly placed into the circle-shaped holes 122. The series of levers can be moved manually or mechanically along the direction of the oblong-shaped grooves 112 to open or close the wells.

In some embodiments, each of the multiple movable bars 125 does not include perforations and instead only includes ones or two circle-shaped holes 122 located at lateral ends of each of the multiple movable bars 125. In such embodiments, aligning a given movable bar 125 to correspond to a row of wells closes the wells. Driving the movable bar 125 to misalign with the row of wells opens the wells.

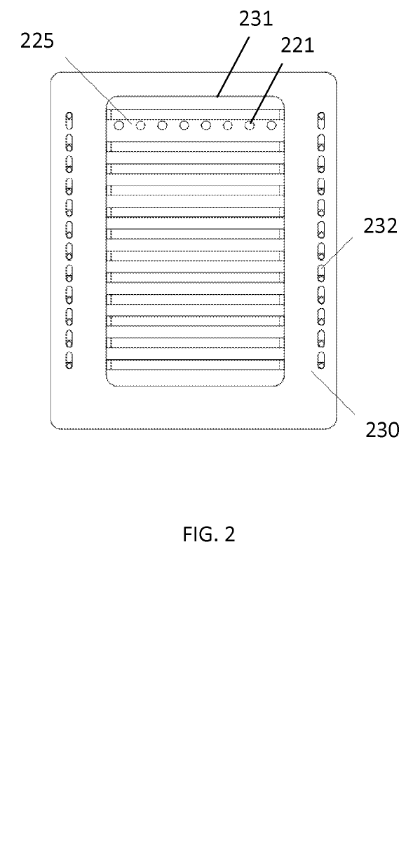

FIG. 2 is a diagram that illustrates a top view of the anti-evaporation device, according to the first aspect of the present invention. As illustrated in FIG. 2, a cover plate 230 can be placed on top of a middle plate such that the cover plate 230 covers the middle plate and a base that is placed below the middle plate. In a preferred embodiment, the cover plate 230 completely covers the middle plate and the base. The cover plate 230 includes an opening 231 that is large enough to expose all wells of the microplate. Multiple movable bars 225 are exposed through the opening 231.

As explained above in relation to FIG. 1, each of the multiple movable bars 225 includes perforations 221 that correspond to wells of a microplate. The number of perforations 221 in each movable bar 225 is equal to the number of wells in a row of the microplate. The size of the perforations 221 can be equal to or smaller than the openings of the microplate wells. The width of the multiple movable bars 225 can be equal to the diameter of the wells. In other embodiments, the width of the multiple movable bars 225 is greater than the diameter of the wells. As referred herein, the width is the shorter dimension of an object (e.g., movable bars), and the length is the longer dimension of the object (e.g., movable bars). In some embodiments, the shape of the openings of the wells may not be a circle and instead be an ellipse. In such embodiments, the diameter of the well is the diameter along the major axis of the ellipse, which is the longest diameter of the ellipse.

The cover plate 230 also includes one or two columns of oblong-shaped holes 232, which are aligned with oblong-shaped grooves of the base. Each movable bar 225 includes one or two circle-shaped holes that are exposed through the oblong-shaped holes 232. In the embodiment illustrated in FIG. 2, the circle-shaped holes are configured to move the corresponding movable bar 225 along the direction of the oblong-shaped holes 232 to open or close corresponding wells of the microplate.

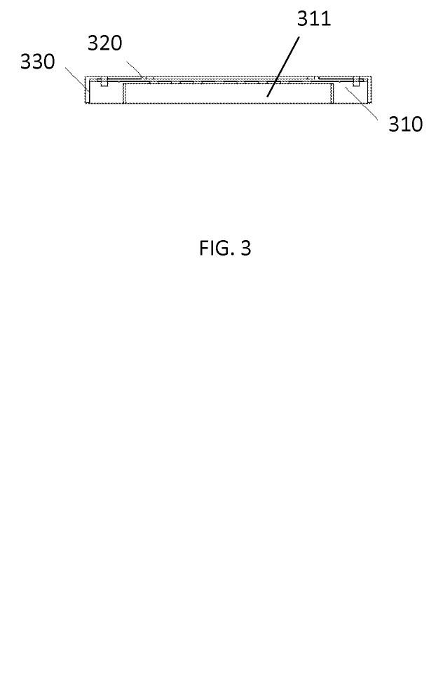

FIG. 3 is a diagram that illustrates a cross-sectional view of the anti-evaporation device, according to some implementations. A microplate 311 is placed within a cavity of a base 310. A middle plate including multiple movable bars is placed on top of the base 310, and a cover 330 can completely enclose the layers of the anti-evaporation device such that the middle plate 320 and the base 310 are not visible when viewed from top of the anti-evaporation device. The layers of the anti-evaporation device are aligned using oblong-shaped grooves and oblong-shaped holes located in the peripheries of each layer.

In the second aspect, the present invention is directed to an apparatus to prevent liquid evaporation in a microplate, comprising: (a) a base having an upper surface and a cavity wherein the cavity is configured to hold a microplate having columns and rows of wells for storing liquids, wherein the upper surface of the base includes a left column and a right column of oblong-shaped grooves each located on opposite lateral ends of the microplate location; (b) a first middle plate on top of the upper surface of the base to cover the cavity, wherein the middle plate comprises (i) a first set of movable bars and (ii) two columns of oblong-shaped holes wherein the two columns of oblong-shaped holes correspond to the left and right columns of oblong-shaped grooves of the base, wherein a number of movable bars in the first set of movable bars is equal to the number of the rows of the wells, each movable bar of the first set of movable bars comprising perforations corresponding to odd-numbered wells of the microplate and at least one circle-shaped hole, and each movable bar of the first set of movable bars is movable along a direction of the oblong-shaped grooves to open or close the odd-numbered wells of each row of the wells; (c) a second middle plate on top of the first middle plate, wherein the middle plate comprises (i) a second set of movable bars, and (ii) two columns of oblong-shaped holes wherein the two columns of oblong-shaped holes correspond to the left and right columns of oblong-shaped grooves of the base, wherein a number of movable bars in the second set of movable bars is equal to the number of the rows of the wells, each movable bar of the second set of movable bars comprising perforations corresponding to even-numbered wells of the microplate and at least one circle-shaped hole, and each movable bar of the second set of movable bars is movable along the direction of the oblong-shaped grooves to open or close the even-numbered wells of each row of the wells; and (d) a cover plate on top of the middle plate and covering the middle plate and the base, wherein the cover plate comprises (i) openings corresponding to the wells of the microplates, and (ii) two columns of oblong-shaped holes, wherein each of the two columns of oblong-shaped holes of the cover plate corresponds to the left and right columns of oblong-shaped grooves of the base.

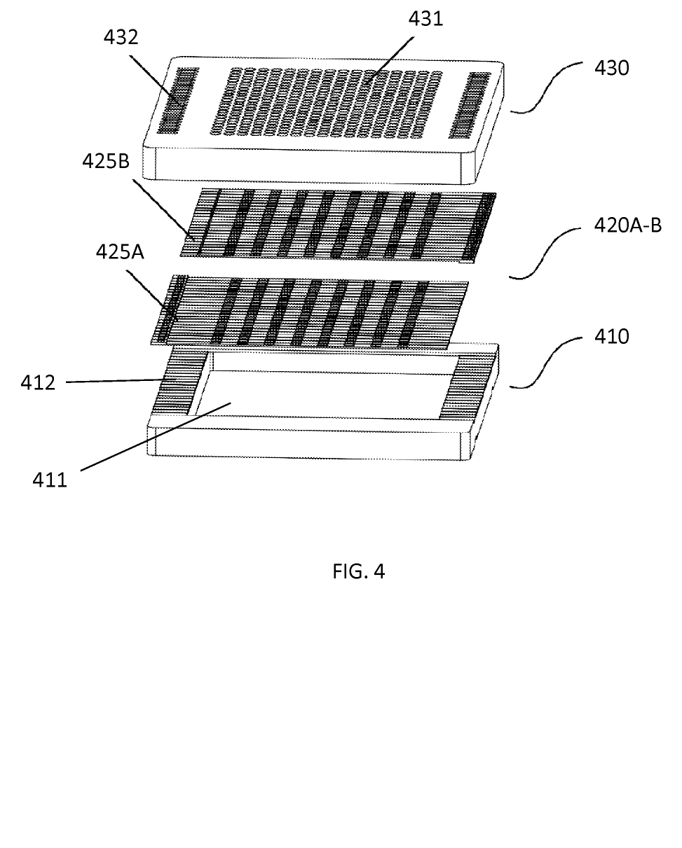

FIG. 4 is one example of a diagram that illustrates an exploded view of the anti-evaporation device, according to the second aspect of the invention. As shown in FIG. 4, the anti-evaporation device includes multiple layers including a base 410, two middle plates 420A-B, and a cover plate 430. The base 410 includes a cavity 411 that is configured to hold a microplate with wells for storing liquids. The base 410 also includes two columns of oblong-shaped grooves 412 located outside of the microplate location on an upper surface of the base 410, wherein each oblong-shaped groove is laterally adjacent to each row of wells of the microplate.

Different from the configuration as illustrated in FIG. 1, the configuration as illustrated in FIG. 4 includes two middle plates 420A-B. The first middle plate 420A placed on top of the upper surface of the base 410 includes a first set of movable bars 425A and one or two columns of oblong-shaped holes corresponding to the two columns of oblong-shaped grooves 412 of the base 410. The number of movable bars in the first set of movable bars 425A is equal to the number of rows of the wells in the microplate. Each movable bar of the first set of movable bars 425A includes perforations corresponding to odd-numbered wells in each row of the microplate. The size of the perforations can be equal to or smaller than the openings of the microplate wells. Each movable bar of the first set of movable bars 425A also includes at least one circle-shaped hole which is configured to be placed above the corresponding oblong-shaped groove of the base 410.

The second middle plate 420B is placed on top of the first middle plate 420A and includes a second set of movable bars 425B and one or two columns of oblong-shaped holes corresponding to the two columns of oblong-shaped grooves 412 of the base 410. The number of movable bars in the second set of movable bars 425B is equal to the number of rows of the wells in the microplate. Each movable bar of the second set of movable bars 425B includes perforations corresponding to even-numbered wells in each row of the microplate. Each movable bar of the second set of movable bars 425B also includes at least one circle-shaped hole which is configured to be placed above the corresponding oblong-shaped groove of the base 410.

The cover plate 430 can be placed on top of the second middle plate 420B such that the cover plate 430 completely or partially covers the other layers of the anti-evaporation device. The cover plate 430 includes openings 431 corresponding to the wells of the microplate and one or two columns of oblong-shaped holes 432 next to the openings 431. In some embodiments, the openings 431 is replaced with a single opening that is large enough to expose all wells of the microplate. The oblong-shaped holes 432 are configured to be aligned with the oblong-shaped grooves 412 of the base 410.

Each movable bar of the first set of movable bars 425A is movable along the direction of the oblong-shaped grooves 412 to open or close odd-numbered holes of the corresponding row of wells in the microplate. As illustrated in FIG. 4, each movable bar moves from left to right. An equipment, such as a driving rod with a diameter less than or equal to that of the circle-shaped holes, can be used to drive the movement of a movable bar of the first set of movable bars 425A. For example, the driving rod can pass through the oblong-shaped hole 432 of the cover plate 430 and the circle-shaped hole of the corresponding movable bar 425A to be securely positioned relative to the corresponding movable bar 425A. The driving rod can drive the perforations to correspond or to misalign with the odd-numbered wells in the corresponding row of wells so as to open or close the odd-numbered wells.

Each movable bar of the second set of movable bars 425A is movable along the direction of the oblong-shaped grooves 412 to open or close even-numbered holes of the corresponding row of wells in the microplate. As illustrated in FIG. 4, each movable bar moves from left to right. A driving rod with a diameter less than or equal to that of the circle-shaped holes can be used to drive the movement of a movable bar of the second set of movable bars 425B. For example, the driving rod can pass through the oblong-shaped hole 432 of the cover plate 430 and the circle-shaped hole of the corresponding movable bar 425B to drive the perforations to correspond or to misalign with the even-numbered wells in the corresponding row of wells so as to open or close the even-numbered wells.

According to the embodiment of the anti-evaporation device illustrated in FIG. 4, three positions for a given row of wells of the microplate are available: 1) opening odd-numbered wells; 2) opening even-numbered wells; and 3) closing all wells in the given row of wells. As illustrated in FIG. 4, the first set of movable bars 425A configured to open or close odd-numbered wells include a circle-shaped hole placed on the left of the perforations. The second set of movable bars 425B configured to open or close even-numbered wells include a circle-shaped hole placed on the right of the perforations.

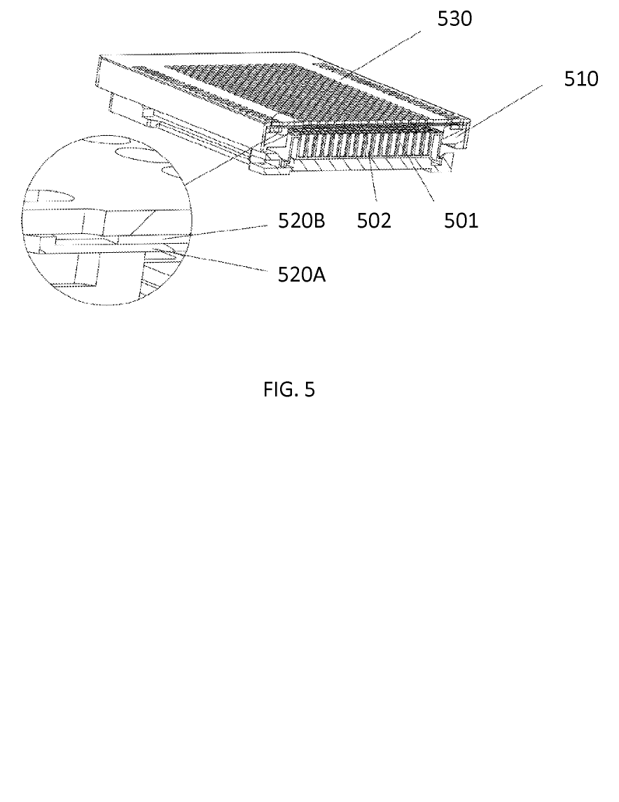

FIG. 5 is a diagram that illustrates a cross-sectional view of the anti-evaporation device, according to some implementations. FIG. 5 illustrates a microplate 501 that is placed in a cavity of a base 510. The microplate 501 includes multiple wells 502, each configured to store liquids. Above the base 510 is a first middle plate 520A and a second middle plate 520B, above which is a cover plate 530.

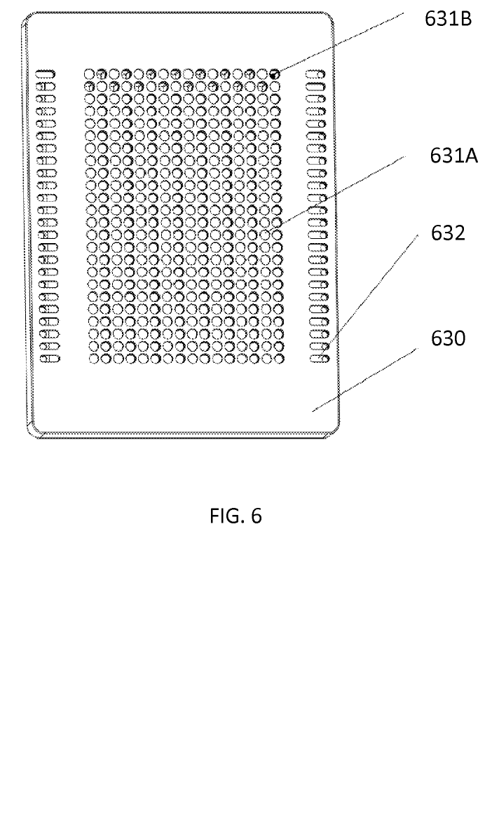

FIG. 6 is a diagram that illustrates a perspective view of the anti-evaporation device, according to the second aspect of the present invention. As illustrated in FIG. 6, a cover plate 630 includes two columns of oblong-shaped holes 632 configured to expose circle-shaped holes of movable bars to enable movement of the movable bars along the direction of the oblong-shaped holes 632 to open or close corresponding wells of a microplate. The cover plate 630 also includes openings 631A-B that correspond to the wells of the microplate. As illustrated in FIG. 6, even-numbered wells of the first row of the microplate are opened, as indicated by openings 631B. In the second row of the microplate, odd-numbered wells are opened as indicated by openings exposing the wells. The wells of other rows remain closed as indicated by openings 631A with closed wells.

For each row of wells of the microplate, the corresponding first movable bar with perforations corresponding to odd-numbered wells and the second movable bar with perforations corresponding to even-numbered wells are staggered such that in a neutral position, all wells in a given row are closed. Moving the corresponding first movable bar along the direction of the corresponding oblong-shaped hole 632 via a driving rod opens or closes the odd-numbered wells of the given row, as demonstrated by the second row of the device of FIG. 6. Returning to the neutral position, moving the corresponding second movable bar along the direction of the corresponding oblong-shaped hole opens or closes the even-numbered wells of the given row, as demonstrated by the first row of the device of FIG. 6.

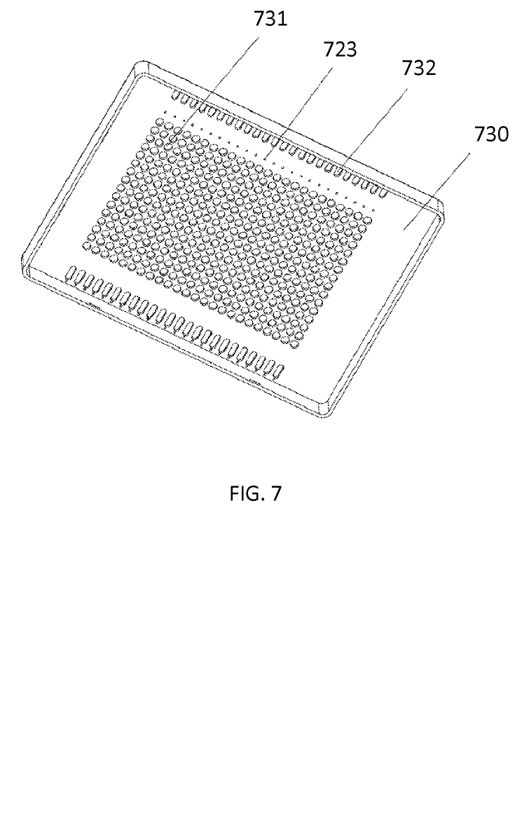

FIG. 7 is a diagram that illustrates another perspective view of the anti-evaporation device, according to the second aspect of the present invention. As illustrated in FIG. 7, a cover plate 730 includes two columns of oblong-shaped holes 732 configured to expose circle-shaped holes of movable bars to enable movement of the movable bars along the direction of the oblong-shaped holes 732 to open or close corresponding wells of a microplate. The cover plate 730 also includes openings 731A-B that correspond to the wells of the microplate. In contrast with the configuration illustrated in FIG. 6, the configuration of FIG. 7 includes slots 723 which are used to align the cover plate 730 with the middle plates. Each of the multiple movable bars of the middle plates includes protruding points configured to engage with the slots 723 in the cover plate 730 to align the layers of the anti-evaporation device.

The present invention is also directed to a method to reduce evaporation of liquids in a microplate having rows and columns of wells. In one embodiment, the method uses the apparatus of the first aspect of the invention. The method comprises the steps of: (a) placing the microplate in the cavity of the base of the apparatus as described in the first aspect of the invention; (b) aligning the middle plate on top of the upper surface of the base; (c) aligning the cover plate on top of the middle plate to cover the middle plate and the base; (d) penetrating a driving rod through a circle-shaped hole of a movable bar such that the driving rod is securely positioned relative to the movable bar; and (e) driving the driving rod along a direction of the corresponding oblong-shaped groove to open or close the corresponding row of wells, whereby the evaporation of the liquids in the wells of the microplate is reduced when the wells are closed.

The present invention is also directed to another method to reduce evaporation of liquids in a microplate having rows and columns of wells. In one embodiment, the method uses the apparatus of the second aspect of the invention. The method comprises the steps of: (a) placing the microplate in the cavity of the base of the apparatus as described in the first aspect of the invention; (b) aligning the first middle plate on top of the upper surface of the base; (c) aligning the second middle plate on top of the first middle plate; (d) aligning the cover plate on top of the second middle plate to cover the first and second middle plates and the base; (e) penetrating a driving rod through a circle-shaped hole of a movable bar such that the driving rod is securely positioned relative to the movable bar; and (f) driving the driving rod along a direction of the corresponding oblong-shaped groove to open or close the corresponding row of wells, whereby the evaporation of the liquids in the wells of the microplate is reduced when the wells are closed.

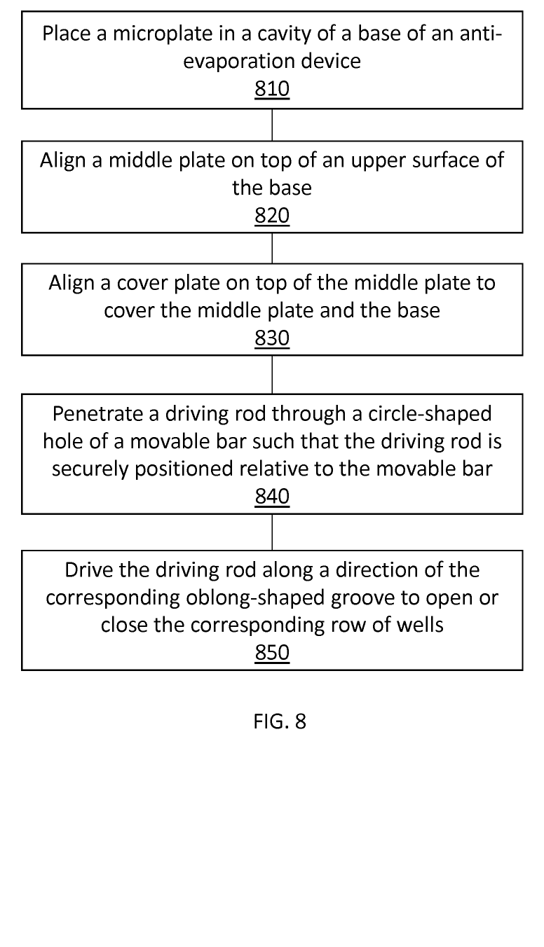

FIG. 8 is a flowchart illustrating a method to reduce or prevent evaporation of liquids in a microplate, according to one embodiment of the first aspect of the invention. At step 810, a microplate having rows and columns of wells is placed in a cavity of a base of an anti-evaporation device. The base of the anti-evaporation device includes oblong-shaped grooves adjacent to the cavity.

At step 820, a middle plate including multiple movable bars configured to align with rows of wells is aligned on top of an upper surface of the base. Each of the multiple movable bars includes a circle-shaped hole that is placed above a corresponding oblong-shaped groove.

At step 830, a cover plate of the anti-evaporation device is aligned on top of the middle plate to cover the middle plate and the base. The cover plate includes an opening corresponding to the cavity and one or two columns of oblong-shaped holes adjacent to the cavity. The alignment can be performed by aligning the oblong-shaped grooves of the base with the oblong-shaped holes of the cover plate. The cover plate can fully enclose or partially cover the middle plate and the base. In some embodiments, the cover plate includes a column of slots, and each of the multiple movable bars includes a protruding point configured to engage with a corresponding column of slots to align the cover plate with the multiple movable bars.

At step 840, a driving rod is configured to penetrate through a selected oblong-shaped hole of the cover plate and the corresponding circle-shaped hole of a movable bar such that the driving rod is securely positioned relative to the movable bar. At step 850, the driving rod is configured to move along a direction of the corresponding oblong-shaped groove to open or close the corresponding row of wells. In embodiments wherein the multiple movable bars include perforations that correspond to the wells of the microplate, aligning a movable bar of the multiple movable bars opens the wells. Misaligning the movable bar closes the wells. Alternatively, in embodiments wherein the multiple movable bars do not include perforations, aligning the movable bar closes the wells, and misaligning the movable bar opens the wells.

While specific examples of technology are described above for illustrative purposes, various equivalent modifications are possible within the scope of the invention, as those skilled in the relevant art will recognize.

1. An apparatus to prevent liquid evaporation in a microplate, comprising:
a base having an upper surface and a cavity wherein the cavity is configured to hold a microplate having columns and rows of wells for storing liquids,
wherein the upper surface of the base includes one or two columns of oblong-shaped grooves located outside of the microplate location, wherein each oblong-shaped groove is laterally adjacent to each row of the wells;
a middle plate on top of the upper surface of the base to cover the cavity, wherein the middle plate comprises (i) multiple movable bars and (ii) one or two columns of oblong-shaped holes wherein the one or two columns of oblong-shaped holes corresponds to the one or two columns of oblong-shaped grooves of the base,
wherein a number of the multiple movable bars is equal to the number of the rows of the wells, each of the movable bars comprising perforations corresponding to the wells of the microplate and at least one circle-shaped hole, and each of the movable bars is movable along a direction of the oblong-shaped grooves to open or close the wells; and
a cover plate on top of the middle plate and covering the middle plate and the base,
wherein the cover plate comprises (i) openings corresponding to the wells of the microplates, and (ii) one or two columns of oblong-shaped holes, wherein the one or two columns of oblong-shaped holes of the cover plate corresponds to the one or two columns of oblong-shaped grooves of the base.

2. The apparatus of claim 1, wherein the upper surface of the base comprises two columns of oblong-shaped grooves each located outside of and adjacent to opposite lateral ends of each row of the wells.

3. The apparatus of claim 1, wherein each of the circle-shaped hole of the movable bars enables movement of the corresponding movable bar along the direction of the oblong-shaped grooves.

4. The apparatus of claim 1, wherein the cover plate fully encloses the middle plate and the base.

5. The apparatus of claim 1, wherein the cover plate comprises a single opening corresponding to the cavity of the base.

6. The apparatus of claim 1, wherein the base and the cover plate are aligned via the oblong-shaped grooves and the oblong-shaped holes.

7. The apparatus of claim 1, wherein the cover plate includes a column of slots, and wherein each movable bar includes a protruding point configured to engage with a corresponding column of slots to align the cover plate with the multiple movable bars.

8. The apparatus of claim 1, wherein a width of the multiple movable bars is equivalent to a diameter of the wells.

9. A method to reduce evaporation of liquids in a microplate having rows and columns of wells, comprising the steps of:
placing the microplate in the cavity of the base of the apparatus of claim 1;
aligning the middle plate on top of the upper surface of the base;
aligning the cover plate on top of the middle plate to cover the middle plate and the base;
penetrating a driving rod through a circle-shaped hole of a movable bar such that the driving rod is securely positioned relative to the movable bar; and
driving the driving rod along a direction of the corresponding oblong-shaped groove to open or close the corresponding row of wells,
whereby the evaporation of the liquids in the wells of the microplate is reduced when the wells are closed.

10. The method of claim 9, wherein aligning the cover plate on top of the middle plate to cover the middle plate and the base further comprises:
aligning the oblong-shaped grooves of the base with the oblong-shaped holes of the cover plate.

11. The method of claim 9, wherein the cover plate comprises a single opening corresponding to the cavity of the base.

12. An apparatus to prevent liquid evaporation in a microplate, comprising:
a base having an upper surface and a cavity wherein the cavity is configured to hold a microplate having columns and rows of wells for storing liquids,
wherein the upper surface of the base includes a left column and a right column of oblong-shaped grooves each located on opposite lateral ends of the microplate location;
a first middle plate on top of the upper surface of the base to cover the cavity, wherein the middle plate comprises (i) a first set of movable bars and (ii) two columns of oblong-shaped holes wherein the two columns of oblong-shaped holes correspond to the left and right columns of oblong-shaped grooves of the base,
wherein a number of movable bars in the first set of movable bars is equal to the number of the rows of the wells, each movable bar of the first set of movable bars comprising perforations corresponding to odd-numbered wells of the microplate and at least one circle-shaped hole, and each movable bar of the first set of movable bars is movable along a direction of the oblong-shaped grooves to open or close the odd-numbered wells of each row of the wells;
a second middle plate on top of the first middle plate, wherein the middle plate comprises (i) a second set of movable bars and (ii) two columns of oblong-shaped holes wherein the two columns of oblong-shaped holes correspond to the left and right columns of oblong-shaped grooves of the base,
wherein a number of movable bars in the second set of movable bars is equal to the number of the rows of the wells, each movable bar of the second set of movable bars comprising perforations corresponding to even-numbered wells of the microplate and at least one circle-shaped hole, and each movable bar of the second set of movable bars is movable along the direction of the oblong-shaped grooves to open or close the even-numbered wells of each row of the wells; and
a cover plate on top of the middle plate and covering the middle plate and the base,
wherein the cover plate comprises (i) openings corresponding to the wells of the microplates, and (ii) two columns of oblong-shaped holes, wherein each of the two columns of oblong-shaped holes of the cover plate corresponds to the left and right columns of oblong-shaped grooves of the base.

13. The apparatus of claim 12, wherein each circle-shaped hole of the first set of movable bars and the second set of movable bars enables movement of the corresponding movable bar along the direction of the oblong-shaped grooves.

14. The apparatus of claim 12, wherein the cover plate fully encloses the middle plate and the base.

15. The apparatus of claim 12, wherein the cover plate comprises a single opening corresponding to the cavity of the base.

16. The apparatus of claim 12, wherein the cover plate includes a column of slots, and wherein each movable bar includes a protruding point configured to engage with a corresponding slot of the cover plate to align the cover plate with the movable bar.

17. The apparatus of claim 12, wherein the perforations of the first set of movable bars and the perforations of the second set of movable bars are staggered so as to close all wells of the microplate.

18. The apparatus of claim 12, wherein the movable bars are made of acrylic board.

19. A method to reduce evaporation of liquids in a microplate having rows and columns of wells, comprising the steps of:
placing the microplate in the cavity of the base of the apparatus of claim 12;
aligning the first middle plate on top of the upper surface of the base;
aligning the second middle plate on top of the first middle plate;
aligning the cover plate on top of the second middle plate to cover the first and second middle plates and the base;
penetrating a driving rod through a circle-shaped hole of a movable bar such that the driving rod is securely positioned relative to the movable bar; and
driving the driving rod along a direction of the corresponding oblong-shaped groove to open or close the corresponding wells of the microplate,
whereby the evaporation of the liquids in the wells of the microplate is reduced when the wells are closed.

20. The method of claim 19, wherein the cover plate comprises a single opening corresponding to the cavity of the base.
